(19) United States
(12) Patent Application Publication
(10) Pub. No.: US 2020/0386850 A1
(43) Pub. Date: Dec. 10, 2020

(54) SYSTEM FOR THE IDENTIFICATION OF EMISSION SOURCES

(71) Applicant: LIMITED LIABILITY COMPANY SCIENTIFIC AND MANUFACTURING COMPLEX DESIGN BUREAU "TARGET", Kyiv (UA)

(72) Inventors: Vitaliy Vasylovych YAKOVLEV, Kyiv (UA); Yuriy Viktorovych RYABKIN, Kyiv (UA); Volodymyr Petrovych BILONOGA, Kyiv (UA); Kostiantyn Mykhailovych YESAVOCHKIN, Gadyach district, Poltava region (UA)

(21) Appl. No.: 16/766,730

(22) PCT Filed: Nov. 26, 2018
(86) PCT No.: PCT/UA2018/000127

§ 371 Date: May 25, 2020

(30) Foreign Application Priority Data
Nov. 30, 2017 (UA) A 2017 11745

(51) Int. Cl. G01S 5/04; G01S 3/74; G01P 15/18; G01C 9/02; G01C 21/20; G01S 5/02

(52) U.S. Cl. CPC G01S 5/04; G01S 3/74; G01S 5/021; G01C 9/02; G01C 21/20; G01P 15/18

(57) ABSTRACT

The present invention discloses a system for identification of emission sources. The system has at least four stations, one being main station. The system operates in 0-6 frequency bands. Each station contains an antenna-feeder system, a multichannel radio receiving path, a control, analysis and signal processing system and a power supply system. The antenna-feeder system comprises a solid metal sheet paraboloid-shaped mirror, a 0 frequency band antenna, compensatory antennas in each of the frequency bands. The system also contains an identification friend or foe and a tactical air navigation (TACAN) systems' signals antenna and a GNSS signals antenna. The radio receiving path provides signals amplification for all bands, converting signals to intermediate frequency. Also the system provides means for timestamping received signals.

### CROSS-REFERENCE TO RELATED APPLICATIONS

The present patent application is a National stage application from PCT application PCT/UA2018/000127 filed on Nov. 26, 2018 which claims priority to Ukranian patent application a 201711745 filed on Nov. 30, 2017, all of which incorporated herein by reference in their entirety.

### FIELD OF INVENTION

The invention relates to radio engineering equipment and can be used to monitor and control emission sources of various classes and systems with pulsed and continuous emission installed on ground, surface and air objects.

### BACKGROUND

The task of identification of emission sources in the radio frequency band is solved in the vast majority of cases by methods of passive radiolocation. In contrast to active radars, passive ones do not allow to determine the range to a source of emission through the reception of signals only by one radar station, and, therefore, in order to determine the coordinates of an emission source, it is necessary to use data received from multiple stations separated from each other at known distances and integrated into the system.

Among the well-known modern monitoring and radar systems are “R & S® UMS300” and “R & S® MP007”, manufactured by German company Rohde & Schwarz (see a brochure “R & S® UMS300 Compact Monitoring and Radiolocation System” and the “R & S® MP007 Portable Direction Finding System” at https://cdn.rohde-schwarz.com). These systems consist of several direction finders using various capabilities of radio frequency (RD) monitoring in accordance with ITU standards and directly acquiring emission sources using the AOA method (Angle of Arrival—at the angle of arrival of signals) according to which the location of emission sources is determined based on the TDOA technique (Time Difference of Arrival—the time difference of signals arrival).

Each DF (direction finding) sensor of the specified monitoring and radar systems uses wideband DF antennas the radio paths of which are made in full compliance with ITU standards and provide for fast scanning of the frequency band from 20 MHz to 6 GHz (optional) and the determination of the carrier frequency, type of modulation, spectrum width of signals of emission sources. In addition to the mode of passive reception of signals there is the possibility of an active radar mode. To supplement any signal of each radio source with an exact timestamp of the start of reception, each DF sensor of these monitoring and radar systems is equipped with a GPS receiver and an Ethernet interface and a router for communication with the main module of monitoring and radiolocation and as an option can also be completed with an additional module for connecting to Mobile Radio Network (GSM, 3G or 4G).

Among distinctive features of the monitoring and radar systems R & SUMSUMS300 and R & S@MP007 are compactness of DF sensors, ease of placement, high rate of frequency scanning, the ability to choose a modernization level of the DF sensors by using variable LRU providing operators with up-to-date software packages with the possibility of upgrade. Some significant deficiencies pertaining to the mentioned systems are: narrowed band of frequency monitoring, small detection range, only stationary placement of DF sensors near the AC mains.

A well-known ESM/ELINT system 85B6-A (“Vega”—Russia), (see Materials of the international exhibition IDEF TURKIYE-99, Sep. 28, 1999-Oct. 1, 1999, Ankara, Turkey. Promotional brochures and leaflets of the company “Rosvooruzhenie”, Peretyagin I, Doctor of Sciences, Three-coordinate ELINT system 85B6-A “Vega”, “Military parade”, January-February 2001) is intended for detection, recognition, classification od emission sources. It comprises several stations of radio frequency monitoring 85B6-COΠ-A (“Orion”), each of which consists of an antenna-feeder device in the form of an antenna array, radio receiving path containing low-noise broadband amplifiers with an electronic switch, a broadband frequency conversion device, an analog device for frequency-time conversion of signals, control, analysis and signal processing equipment comprising a pre-digital processing device, a device for changing the parameters of direction finding of emission sources, personal computer (PC) for data management and processing.

ELINT system “Vega” provides for direction finding of emission sources through fast scanning of frequency spectrum, detection of signals from sources of radio emission in a wide band of frequencies, including short-term waveforms, some types of complex and noise-like signals, recognition, determination of their parameters and software-based identification of radio emission sources (attribution to specified classes or types of objects) with the results output on displays of the computing system (PC).

Among the drawbacks of the ELINT system “Vega” is an insufficient degree of input signals processing resulting in poor quality of output data, insufficient DF accuracy and detection range of radio emission sources, and inability to receive and determine the parameters of modern complex waveforms (multiple frequency signals, wobbling, etc.).

The closest analog in terms of technical details to the proposed technical solution is a system that can be made using a station of monitoring RF spectrum (see the patent of Ukraine No. 97271, IPC G01S 3/02, G01S 13/66). The station contains an antenna-feeder system with a support-turning device and calibration equipment, a radio receiver path with an automated workplace, a control, analysis and signals processing system, and a power supply system that feeds power to all components of the station for the identification of emission sources. The antenna-feeder system contains an antenna mirror of 1-4 frequency bands with a unit of feeders of 1-4 frequency bands and an antenna system of 0-frequency band comprising two antennas that collectively provide in each of 0-4 frequency band both left and right lobes of the antenna-feeder system direction patterns and a compensatory antenna with a weakly-directed direction pattern as well as antennas of 4-6 frequency bands.

The support-turning device a signal input of which is connected to first output of the control, analysis and signals processing system and a power input is connected to first output of the power system, enables scanning of an area within a 3600 range at azimuth. The calibration equipment consists of a control module, a multi-channel oscillator of reference signals and high-frequency switches in each frequency bands.

First inputs of high-frequency switches are connected to outputs of all antennas in each frequency band. Second inputs of high-frequency switches are connected to outputs of a multi-channel oscillator of reference signals. Outputs of high-frequency switches of reference signals serve as outputs of the antenna-feeder system and inputs of high-frequency switchers of reference signals are connected to the corresponding outputs of the control unit of the calibration equipment. Data entry of this module is connected to first output of the automated workplace.

Radio receiving path contains an automated workplace, a multi-channel radio receiver with “HF-IF” channels in each of 0 to 4 frequency bands for processing signals of left and right lobes of the antenna-feeder direction patterns and a compensatory antenna signal in 0 frequency band and the multichannel unit for the formation of video signals of left and right lobes of the antenna-feeder direction patterns and a video signal of the compensatory antenna in 0 frequency band.

A video signals switching unit and an intermediate frequency (IF) switching unit are connected to the corresponding outputs of “HF-IF” channels in each of 0 to 4 frequency bands. Each “HF-IF” channel consists of a series-connected high frequency filter, a pre-amplifier of high frequency, an attenuator of high frequency, an amplifier-converter “high frequency—intermediate frequency”, an intermediate frequency filter, an amplifier of intermediate frequency, an attenuator of intermediate frequency.

An input of the high-frequency filter is an input of the “HF-IF” channel and is connected to the corresponding output of the antenna-feeder system. The output of an intermediate frequency (IF) attenuator is output of a “HF-IF” channel. Control inputs of high and intermediate frequency attenuators as well as control inputs of amplifiers-converters, “high frequency—intermediate frequency” of each of the “HF-IF” channels are connected to second output of the automated workplace.

In a multi-channel video signals formation unit, each channels of which consists of a series-connected amplitude detector, an amplifier of video signals, a threshold device and a time strobe generator, an input of the amplitude detector is an input of a channel of the multichannel video signals formation unit, and an output of the time strobe generator is an output of a channel of the multichannel video signals formation unit. All outputs of the time strobe generators are connected to the corresponding inputs of the video signals switching unit all control inputs of which are connected to third output of the automated workplace, and an output of the video signals switching unit is connected to first input of the station's computing system.

Control input of the intermediate frequency (IF) signals switching unit is connected to third output of the automated workplace, and outputs of the IF signals switching unit are outputs of the radio path of left and right lobes of direction patterns of a selected frequency band at intermediate frequency. The automated workplace is connected with the station's computing system via a two-way communication line. The control, analysis and signals processing system contains a station's computing system and a GNSS receiver interconnected via two-way communication lines.

The Global Navigation Satellite System (GNSS) receiver's input is connected to an antenna output of GNSS signals. The automated workplace also contains a receiver and a decoder of signals of air traffic control (ATC) system an input of which is connected to an output of the antenna receiving signals of the ATC system, the system of signals selection, the direction finding (DF) equipment, a device for recognition of emission sources and control system of the antenna-feeder system. At the same time, an output of the signals selection system is connected to the control input of DF equipment.

Among advantages of the system of RF spectrum monitoring is mobility, an ability to perform main tasks for the identification, recognition, classification and tracking ground, sea and air objects through the reception of electronic emissions of their own electronic equipment virtually anywhere in the globe. Disadvantages are: high probability of false alarms in determining coordinates of radio emission sources due to possible reception of signals by side lobes of the direction pattern of the antenna-feeder system.

Also, the complexity of algorithms for the determination of bearings to radio emission sources which demands high level of proficiency from operators of ELINT stations, low DF accuracy due to possible inclination of the platform with the antenna-feeder system during scanning, low level of automation of determining current coordinates of radio sources, insufficient detection range, the complexity of routine maintenance works during operation to ensure all basic parameters of ELINT stations are constantly met.

### SUMMARY

The basic task of the invention is to increase the probability of correct determination of coordinates of radio emission sources, to expand the operating modes of the system with the automatic identification of emission sources, to increase detection range of the system and to ensure stability of its parameters during operation.

This problem is solved in such a way that the system for the identification of emission sources consisting of at least four stations for the identification of emission sources. The first main station for the identification of emission sources of 0-6 frequency bands contains an equipment suite for processing own data and data taken from other stations with the use of specialized software for the calculation of coordinates. The remaining three stations for the identification of emission sources are located at distances of 20-30 kilometers from the first main station.

Each station for the identification of emission sources contains an antenna-feeder system with a support-turning device and the calibration equipment, a radio receiver path with an automated workplace, a control, analysis and signals processing system, a levelling system and a power supply system that provides energy to all components of the station for the identification of emission sources.

The antenna-feeder system comprises a mirror made of a solid metal sheet as a part of a paraboloid of 1-4 frequency bands with a unit of feeders of 1-4 frequency bands which collectively provide in each of 1-4 frequency bands of left and right lobes of the direction patterns of the antenna-feeder system.

The antenna feeder system also contains an antenna system of 0 frequency band comprising two antennas ensuring left and right lobes of direction pattern and a compensatory antenna with a weakly-directed direction pattern. The support-rotary device provides scanning of an area within a 3600 range at azimuth. The calibration equipment consists of a control module, a multi-channel generator of reference signals and high-frequency switches in each frequency band.

First inputs of high-frequency switches are connected to outputs of all antennas in each of the frequency bands. Outputs of high-frequency switches are outputs of the antenna-feeder system, and control inputs of high-frequency switches are connected to the corresponding outputs of a control module of the calibration equipment, a data input of which is connected to first output of the automated workplace.

The radio receiving path also contains a multi-channel radio receiver with “HF-IF” channels in each of 0 to 4 frequency bands for processing signals of left and right lobes of the antenna feeder direction patterns, and an “HF-IF” channel for processing signals of the compensatory antenna of 0 frequency band, channels for the formation of video signals of left and right lobes of the antenna-feeder direction patterns and a video signal of the compensatory antenna of 0 frequency band, a video signals switching unit and the IF signals switching unit which is connected to the corresponding outputs of “HF-IF” channels and the inputs of channels for the formation of video signals in each of 0 to 4 frequency bands.

Each “HF-IF” channel consists of a series-connected high frequency filter, a pre-amplifier of high frequency, an attenuator of high frequency, an amplifier-converter “high frequency—intermediate frequency”, an intermediate frequency filter, an amplifier of intermediate frequency, an attenuator of intermediate frequency. An input of the high-frequency filter is an input of a “HF-IF” channel and is connected to the corresponding output of the antenna-feeder system. The output of the intermediate frequency attenuator is the output of the “HF-IF” channel. Control inputs of high and intermediate frequency attenuators, as well as control inputs for amplifiers-converters “high frequency—intermediate frequency” of each of “HF-IF” channels are connected to second output of the automated workplace.

Each channel for the formation of video signals consists of a series-connected amplitude detector, an amplifier of video signals, a threshold device and a time strobe generator. An input of an amplitude detector is an input of a channel for the formation of video channels. An output of a time strobe generator is an output of a channel for the formation of video signals. All outputs of the video signal forming channels are connected to the corresponding inputs of the video signals switching unit and the automated workplace. Control inputs of the video signals switching unit and the intermediate frequency signals switching unit are connected to third output of the automated workplace. Outputs of the video signals switching unit and outputs of the intermediate frequency signals switching unit, which are video signal outputs and outputs at intermediate frequency of the radio receiving path of left and right lobes of the direction pattern of the selected frequency band, are connected to the corresponding inputs of the station's computing system.

The control, analysis, and signals processing system comprises a station's computing system connected via two-way communication lines to an automated workplace and a GNSS receiver an input of which is connected to an output of an antenna receiving signals of global positioning systems, a receiver and a decoder of IFF signals. An input of the decoder is connected to an output of an antenna receiving IFF and TACAN signals.

The computing system of the station is also connected to the signals selection system, direction finding equipment, a device for recognition of emission sources and the control system of the support-turning device of the antenna-feeder system. An output of the signals selection system is connected to a control input of the DF equipment. The computing system of the main station is connected via a secured local data exchange network with the equipment for the determination of coordinates of emission sources located on it and with computer systems of other stations of the system.

In accordance with the conception of the invention, the antenna-feeder system has been enhanced with the addition of compensatory antennas of 1 to 4 frequency bands with weakly-directed direction patterns and antennas with circular direction patterns 4 of 5/6 frequency bands as well as a frequency band of signals emitted by IFF/TACAN systems.

Digitally-controlled attenuators have been added to a suite of calibration equipment of the antenna-feeder system in each of the frequency bands between outputs of generators of the reference signals and other inputs of the high-frequency switches. Control inputs of the attenuators are connected to additional outputs of the control unit of the calibration equipment. “HF-IF” channels and the video signal processing channels for processing of signals received by compensatory antenna of 1 to 4 frequency bands with weakly-directed direction patterns are additionally added to the radio receiving path. Outputs of these “HF-IF” channels are connected to the corresponding additional inputs of the intermediate frequency signal switching unit and inputs of additionally added video signals processing channels the outputs of which are connected to the corresponding additional inputs of the video signals switching unit and the automated workplace.

An “HF-IF” channel for processing signals of an antenna with a circular direction pattern in the frequency band of signals of the tactical air navigation system (TACAN), an n-channel signal multiplier and an n “HF-IF” channels for processing signals of the antenna with a circular direction pattern in 5/6 frequency bands, an m-channel signals multiplier and m-channels “HF-IF” for processing signals of an antenna with a circular direction pattern in 4 frequency band.

The control, analysis and signals processing system additionally contain, a one-channel meter of frequency and time parameters of signals of tactical air navigation system (TACAN) an input of which is connected to an output of the “HF-IF” channel for processing signals of the tactical air navigation system (TACAN). Also, n single-channel meters of frequency and time parameters of signals in 5/6 frequency bands inputs of which are connected to outputs of “HF-IF” n channels for the processing of signals of an antenna with a circular direction pattern in 5/6 frequency bands and m single-channel meters have been additionally added to the system. Frequency and time parameters of signals in 4 frequency bands inputs of which are connected to outputs of m channels “HF-IF” for processing signals of an antenna with a circular direction pattern in 4 frequency bands.

A three-channel meter of frequency and time parameters of signals all inputs of which are connected to outputs of the intermediate frequency signals switching unit. All single-channel meters of frequency and time parameters of signals and a three-channel meter of frequency and time parameters of signals are connected to the station's computing system via additional two-way communication lines. The equipment of each station for the identification of emission sources is installed on chassis of a specialized cargo vehicle with an enhanced off-road capability.

The levelling system of each station for the identification of emission sources consisting of four moving supports mounted at sides of the chassis, is made automatic utilizing four gear motors which enable vertical movement of supports and horizontal sensors fixed on the platform of the support-turning device and/or on the chassis, as well as the control module the signal inputs of which are connected to outputs of horizontal sensors.

Four outputs of the control module are connected to power inputs of the respective motor-reducers and the control module is connected by a two-way communication link with the station's computing system. Compensatory antennas of 1 to 4 frequency bands can be used with circular direction patterns or with a “cardioid” type direction patterns an angular maximum coordinate of which differs by 180° from the arithmetic mean of angular coordinates of maximum of left and right lobes of the antenna-feeder system direction patterns in the corresponding frequency band. In addition, a mirror of the antenna-feeder system is made of an area of at least 4.25 m2.

The following distinctive features pertaining to the system in question, unlike analogous systems, include:
addition of compensatory antennas of 1 to 4 frequency bands with weakly-directed direction patterns into the antenna-feeder system;
addition into the antenna-feeder system of antennas with circular direction patterns 4, 5/6 frequency bands as well as frequency band of signals emitted by the IFF—Identification Friend or Foe equipment and tactical air navigation system (TACAN);
addition of a digitally-controlled multichannel attenuator to the antenna-feeder systems' calibration equipment in each of the frequency bands between the outputs of the multichannel oscillator of reference signals and first inputs of high-frequency switches. All control inputs of the attenuator are connected to additional outputs of a control unit of the calibration equipment;
addition into the radio path in each of 1 to 4 frequency bands of additional “HF-IF” channels and video signal processing channels for the processing of signals received by the compensatory antennas of 1 to 4 frequency bands with weakly-directed direction patterns. All outputs of the “HF-IF” channels are connected to the corresponding additional inputs of a unit of IF signals switching. Outputs of the video signals processing channels are connected to the corresponding additional inputs of the video signals switching unit;
addition into the radio frequency path of a channel “HF-IF” for the procession of signals of an antenna with a circular direction pattern in the frequency band of the signals emitted by the IFF—Identification Friend or Foe equipment and tactical air navigation system (TACAN);
addition into the radio frequency path of an n-channel signals multiplier and n channels of “HF-IF” for processing of signals of an antenna with circular direction pattern in 5/6 frequency bands;
addition into the radio frequency path of an m-channel signals multiplier and m channels “HF-IF” for processing of signals of the antenna with circular direction pattern in 4 frequency band;
addition into the control, analysis and signals processing system of a single-channel meter to measure frequency and time parameters of signals emitted by the IFF—Identification Friend or Foe equipment and tactical air navigation system (TACAN). An input of the meter is connected to an output of an “HF-IF” channel for processing signals of the tactical air navigation system;
addition into the control, analysis and signals processing system of n single-channel meters to measure frequency and time parameters of signals of 5/6 frequency bands. Their inputs are connected to outputs of n “HF-IF” channels for processing signals of the antenna with a circular direction pattern of 5/6 frequency bands;
addition into the control, analysis and signals processing system of m single-channel meters to measure frequency and time parameters of signals of 4 frequency band the inputs of which are connected with outputs of m “HF-IF” channels for processing signals of the antenna with a circular direction pattern in 4 frequency band;
addition into the control, analysis and signals processing system of a three-channels meter to measure frequency and time parameters of signals. Inputs of the meters are connected to outputs of the IF signals switching unit;
connection of all single-channel meters measuring frequency and time parameters of signals and a three-channel meter measuring frequency and time parameters of signals with the station's computing system via additional two-way communication lines;
mounting of the whole equipment suite of each station for the identification of emission sources on chassis of one customized enhanced off-road ability cargo vehicle;
automation of the levelling system, consisting of four movable supports placed at sides of the chassis' beams, in each station for the identification of emission sources by means of four gear motors ensuring the possibility of vertical movement of movable supports, horizontal plane sensors fixed on a platform of the support-turner and/or on the chassis, and the control module the signal inputs of which are connected to outputs of the horizontal plane sensors. Four outputs of the control module are connected to power inputs of the modules of the corresponding gear motors. The control unit is connected to the station's computing system via an information bus;
the use of compensatory antennas with circular direction patterns in 1-4 frequency bands;
the use of compensatory antennas of 1 to 4 frequency bands with direction patterns of a “cardioid” type the angular maximum coordinate of which has a difference of 1800 from the arithmetic mean of angular coordinates of maximum of left and right lobes of the antenna-feeder system's direction patterns in the corresponding frequency band;
fabrication of a mirror of the antenna-feeder system with an area of at least 4.25 m².

### DETAILED DESCRIPTION OF THE PREFERRED EMBODIMENT

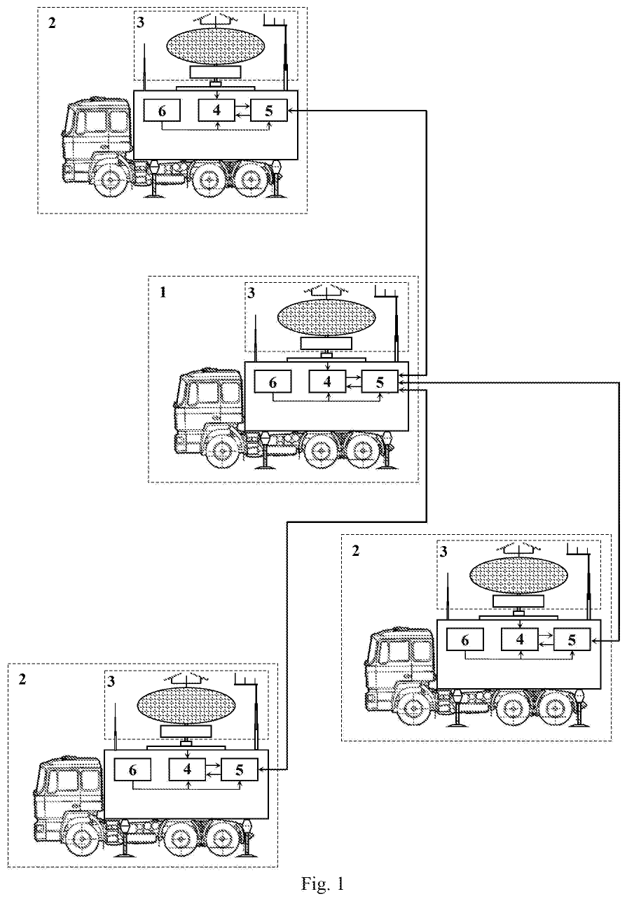

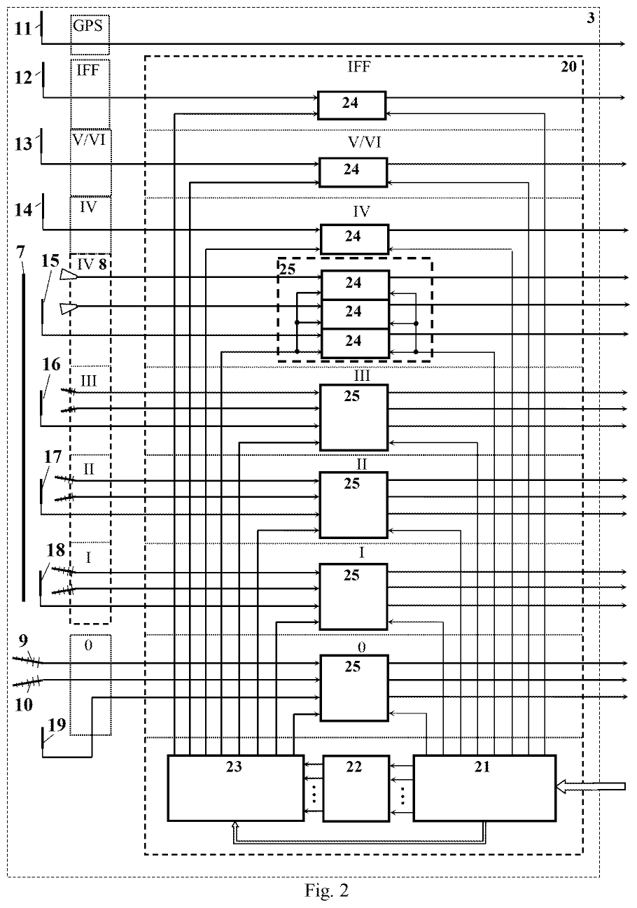

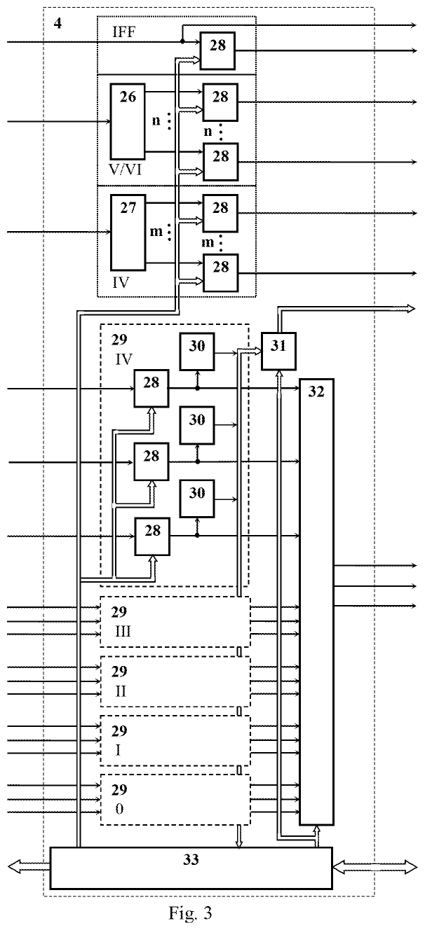

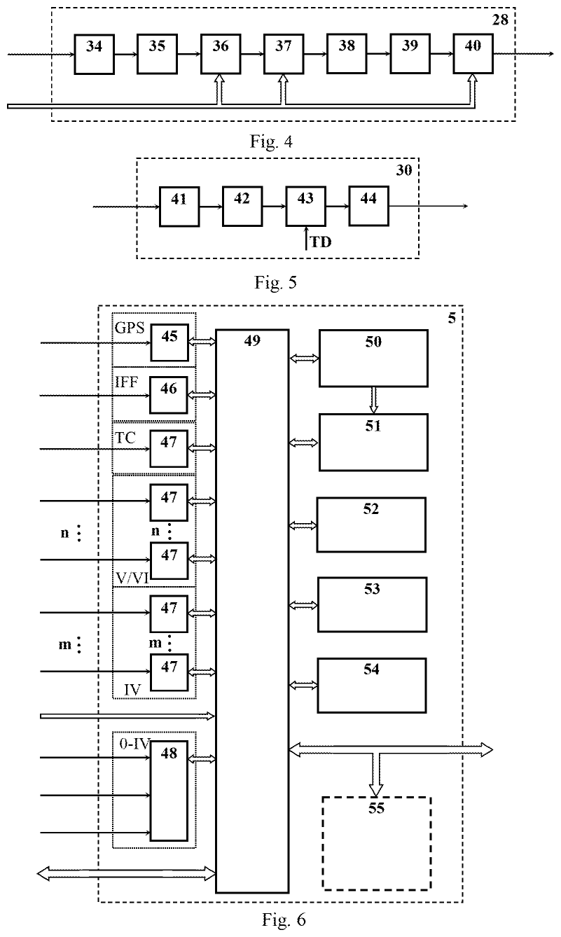

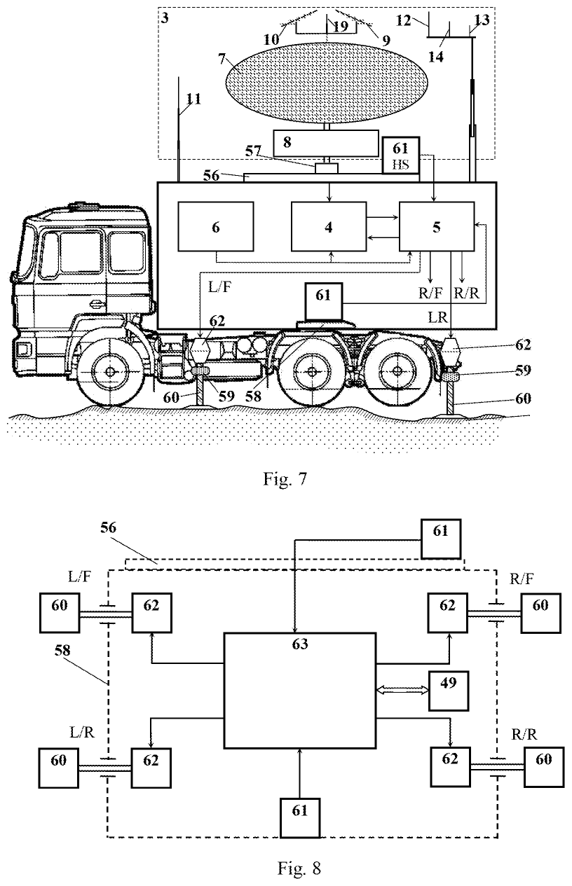

The invention is further explained in FIG. 1 which depicts the location of the stations for identification of emission sources; FIG. 2 shows all main components of the antenna-feeder system of the station for the identification of emission sources; FIG. 3 schematically depicts the main components of the radio receiving path of the station for the identification of emission sources; FIG. 4 shows a simplified block diagram of a channel “HF-IF”; FIG. 5 shows a simplified block diagram of a channel forming video signals in the radio receiving path; FIG. 6 depicts a functional block diagram of the control, analysis and signals processing system of the station for the identification of emission sources; FIG. 7 shows the location/placement of all constituent components of the automatic levelling system on chassis of to station for the identification of emission sources; and FIG. 8 depicts a block diagram of the automatic levelling system of a station for the identification of emission sources.

In order to facilitate the perception of how all elements are interrelated in a station for the identification of emission sources, Table 1 shows designations of the elements, their main functional purpose and the figures numbers where these elements are available.

TABLE 1
Table 1.

| No μ/μ | Explanation | FIG. |
|---|---|---|
| 1 | The main station for the identification of emission sources - solves all tasks | 1 |
| | dealt with by a station for the identification of emission sources (2), and the | |
| | determination of all coordinates of emission sources based on data provided | |
| | by other stations of the system for the identification of emission sources | |
| 2 | A station for the identification of emission sources - provides for detection, | 1 |
| | identification and determination of azimuth coordinates of emission sources | |
| | as well as coordinates of airborne objects through the reception of signals | |
| | emitted by IFF - Identification Friend or Foe, and tactical air navigation | |
| | system (TACAN) | |
| 3 | The antenna-feeder system (AFS) - enables the reception of high-frequency | 1, 2, 7 |
| | signals (HF): 0-band (0.13-0.47 GHz), 1-st (0.75-2.00 GHz), 2-nd (2.00-4.00 | |
| | GHz), 3rd (4.00-8.00 GHz), 4th (8.00-12.00 GHz), 5th (12.00-15.00 GHz) and | |
| | the 6th (15.00-18.00 GHz) frequency bands as well as the signals of the IFF | |
| | system and the tactical air navigation system in the frequency bands (0.730- | |
| | 0.813 GHz) and (1.025-1.150) GHz as well as and GNSS signals | |
| 4 | Radio receiving path - in all frequency bands provides for filtration, | 1, 3, 7 |
| | amplification of HF signals, conversion them to intermediate frequency (IF), | |
| | amplification of the IF signals with the possibility of changing the transfer | |
| | ratio of the radio receiving path | |
| 5 | The control, analysis and signals processing system - controls all operation | 1, 6, 7 |
| | modes of the station (1) and (2) for the identification of emission sources, | |
| | analysis and processing of signals, generates commands for all components of | |
| | stations (1) and (2) for the identification of emission sources | |
| 6 | Power supply system - provides power supply voltage for all components of | 1, 7 |
| | the stations (1) and (2) for the identification of emission sources | |
| 7 | A mirror of the AFS of 1-4 frequency bands - provides for the reception of | 2, 7 |
| | electromagnetic signals of emission sources in the frequency bands and | |
| | reflects them in the direction of an antenna feeders unit (8) | |
| 8 | The antenna feeds unit for 1-4 frequency bands - is intended for placement of | 2, 7 |
| | illuminators (feeds) forming a two-beam direction pattern (DP) in a horizontal | |
| | plane in these frequency bands | |
| 9 | An antenna of right lobe of the direction pattern (DP) of 0 frequency band - | 2, 7 |
| | forms right lobe of the DP in the horizontal plane of 0 frequency band | |
| 10 | An antenna of left lobe of the direction pattern (DP) of 0 frequency band - | 2, 7 |
| | forms left lobe of the DP in the horizontal plane of 0 frequency band | |
| 11 | A GNSS antenna with circular direction pattern - provides for the reception | 2, 7 |
| | of signals emitted by GNSS in the range of azimuth angles of 360° | |
| 12 | An antenna receiving signals emitted by the IFF system and tactical air | 2, 7 |
| | navigation system TACAN - circular direction pattern of the antenna provides | |
| | for the reception of all signals emitted by these systems within a 360° sector | |
| | of azimuth angles | |
| 13 | An antenna receiving signals of 5/6 frequency bands with circular direction | 2, 7 |
| | pattern - provides for the reception of signals in 5/6 frequency bands within a | |
| | 360° sector of azimuth angles | |
| 14 | An antenna receiving signals of 4 frequency band with a circular direction | 2, 7 |
| | pattern - provides for the reception of signals in 4 frequency band within a | |
| | 360° sector of azimuth angles | |
| 15 | An antenna receiving signals of 4 frequency band with weakly-directed | 2 |
| | direction pattern - ensures the reception of signals in 4 frequency band with | |
| | gain factor higher than side lobes of the two-beam direction pattern in the | |
| | horizontal plane in this frequency band | |
| 16 | An antenna receiving signals of 3 frequency band with weakly-directed | 2 |
| | direction pattern - ensures the reception of signals in 3 frequency band with | |
| | gain factor higher than side lobes of the two-beam direction pattern in the | |
| | horizontal plane in this frequency band | |
| 17 | An antenna receiving signals of 2 frequency band with weakly-directed | 2 |
| | direction pattern - ensures the reception of signals in 2 frequency band with | |
| | gain factor higher than side lobes of the two-beam direction pattern in the | |
| | horizontal plane in this frequency band | |
| 18 | An antenna receiving signals of 1 frequency band with weakly-directed | 2 |
| | direction pattern - ensures the reception of signals in 1 frequency band with | |
| | gain factor higher than side lobes of the two-beam direction pattern in the | |
| | horizontal plane in this frequency band | |
| 19 | An antenna receiving signals of 0 frequency band with weakly-directed | 2 |
| | direction pattern - ensures the reception of signals in 0 frequency band with | |
| | gain factor higher than side lobes of the direction pattern in the horizontal | |
| | plane of the antennas (9) and (10) | |
| 20 | Calibration equipment - provides for the formation of signals to control gain | 2 |
| | factor of HF attenuators (36) and IF attenuators (40) of channels “HF-IF” (28) | |
| | of the radio frequency path (4) | |
| 21 | Control unit of the calibration equipment - provides for the formation of | 2 |
| | control signals for some elements of the calibration equipment (20) through | |
| | commands generated by the automated workplace (AW) (33) | |
| 22 | A multi-channel reference signals generator of the calibration equipment | 2 |
| | through the reception of signals of the calibration equipment control module | |
| | (21) ensures the formation of HF test signals in each of the 0 to 6 frequency | |
| | bands and in the frequency band of the signals emitted by the IFF system | |
| | equipment and the tactical air navigation system (TACAN) | |
| 23 | A multichannel attenuator of reference signals of the calibration equipment | 2 |
| | through the reception of signals of the calibration equipment control module | |
| | (21) provides for the attenuation of output signals of the high-frequency | |
| | multichannel generator (22) of reference signals of calibration equipment | |
| 24 | A single-channel high-frequency switch (selector) - sends an operational or a | 2 |
| | test HF signal of the corresponding frequency band to its output of at the | |
| | signals of the calibration equipment control module (21) | |
| 25 | A three-channels high frequency switch - sends to its output of three | 2 |
| | operational or a multiplied HF test signal of the corresponding frequency band | |
| | by the signals of the calibration equipment control module (21) | |
| 26 | An n-channel multiplier of HF signals of 5/6 frequency band - sends input | 3 |
| | signals of 5/6 frequency bands of n channels “HF-IF” (28) of the radio path (4) | |
| 27 | An m-channel multiplier of HF signals of 4 frequency band - feeds input | 3 |
| | signals of 4 frequency band of m channels “HF-IF” (28) of the radio path (4) | |
| 28 | A HF-IF channel - ensures filtration, amplification and controlled attenuation | 3, 4 |
| | of HF signals of the corresponding frequency band, converting them to IF, | |
| | filtration, amplification and controlled attenuation of all IF signals | |
| 29 | A three channel HF signals processing unit - provides for full processing of | 3 |
| | three signals of one of 0 to 4 frequency bands | |
| 30 | A video signal (VS) processing channel - provides for the amplitude detection, | 3, 5 |
| | amplification of received video signals, selection of video signals of a certain | |
| | amplitude and the formation of digital signals from selected video signals | |
| 31 | A time strobes switching unit - enables switching of time strobes | 3 |
| 32 | A IF signals switching unit - provides for the processing and switching of IF | 3 |
| | signals of 0-4 frequency bands | |
| 33 | An automated workplace (AW) of a station - ensures operation of the stations | 3 |
| | (1) and (2) for the identification of emission sources, display of air situational | |
| | picture and parameters of detected sources of emission | |
| 34 | A HF filter - passes HF signals of the corresponding frequency band | 4 |
| 35 | A HF amplifier - amplifies HF signals of the corresponding frequency band | 4 |
| 36 | An HF attenuator - adjusts gain of HF signals of the corresponding frequency | 4 |
| | band | |
| 37 | A HF-IF converter-amplifier - converts HF signals of the corresponding | 4 |
| | frequency band to IF signals | |
| 38 | A IF filter - passes IF signals | 4 |
| 39 | An IF amplifier - amplifies IF signals | 4 |
| 40 | An IF attenuator - adjusts gain factor of IF signals | 4 |
| 41 | An amplitude detector - detects IF signals | 5 |
| 42 | An HF amplifier - amplifies HF signals | 5 |
| 43 | A thresholder - passes video signals of a certain amplitude | 5 |
| 44 | A time strobe generator - generates time strobes | 5 |
| 45 | A GNSS signals receiver - provides for the reception of GNSS signals, | 6 |
| | decoding and data transmission to the station's computing system (SCS) (49) | |
| 46 | A receiver and decoder of the IFF signals - provides for the reception of IFF | 6 |
| | signals, decoding and data transmission to the station's computing system | |
| | (SCS) (49) | |
| 47 | A single channel meter of frequency and time parameters of signals - provides | 6 |
| | for the measurement of the carrier frequency values and time parameters of | |
| | pulse sequences of signals of a certain frequency band | |
| 48 | A three-channels meter of frequency and time parameters of signals - provides | 6 |
| | for the measurement of the carrier frequency values and time parameters of | |
| | pulse sequences of signals from one of 0 to 4 frequency bands | |
| 49 | The station's computing system (SCS) - generates algorithms and programs | 6 |
| | for control, analysis, signals processing and control commands for all | |
| | component parts of stations (1) and (2) for the identification of emission | |
| | sources | |
| 50 | Signals selection system - selects useful signals against the background of | 6 |
| | interferences and noise | |
| 51 | Direction finding (DF) equipment - defines bearings to all sources of emission | 6 |
| | received by the AFS (3), signals of which are processed by single-channel | |
| | meters (47) and a three-channels meter measuring (48) frequency and time | |
| | parameters of signals | |
| 52 | A device for the identification of classes of emission sources - provides for | 6 |
| | the identification of classes of emission sources according to certain criteria. | |
| 53 | The levelling system - enables possibility of mounting a platform of the | 6, 8 |
| | support-turner (ST) in the horizontal position by commands from the SCS (49) | |
| 54 | Support-turner (ST) control system - selects azimuth direction of the AFS | 6 |
| | receiving signals (3) by commands from the SCS (49) | |
| 55 | Equipment for the determination of coordinates of emission sources (only in | 6 |
| | the main station) - provides for the determination of geographic coordinates | |
| | and barometric height of detected sources of emission based on data from all | |
| | stations (1) and (2) for the identification of emission sources | |
| 56 | A support-turner (ST) platform is a constituent part of the support-turner | 7, 8 |
| | control system (54) on which the AFS is mounted (3). It can rotate around | |
| | vertical axis | |
| 57 | A gear motor of the support-turner - an actuator which is part of the support- | 7 |
| | turner (ST) control system (54) and provides the rotation of the support-turner | |
| | (ST) platform (56) | |
| 58 | Chassis - designed to accommodate all components of stations (1) and (2) for | 7, 8 |
| | the identification of emission sources | |
| 59 | The chassis' beams of the levelling system are a constituent component of the | 7, 8 |
| | chassis relative to which the moving support (61) of the levelling system | |
| | moves along (53) | |
| 60 | A movable support of the levelling system is a constructive part of the | 7, 8 |
| | levelling (53) and provides vertical movement of the corresponding beam of | |
| | the chassis (59) relative to the earth's surface | |
| 61 | Horizon sensors - sensors, accelerometers providing signals of deviation from | 7, 8 |
| | the horizontal position | |
| 62 | A motor-reducer of the levelling system - an actuator that is part of the | 7, 8 |
| | levelling system (53) and provides movement of the corresponding movable | |
| | support (61) | |
| 63 | A control unit of the levelling system - provides movement of movable | 8 |
| | supports (61) according to the horizon sensor (58) at time intervals defined by | |
| | the commands of the SCS (49) | |

FIG. 1 shows possible terrain location of stations 1 and 2 for the identification of emission sources. Location of the main station 1 for the identification of emission sources is desirable (but not mandatory) in the center of an imaginary circle around the triangle the vertices of which are geographic coordinates of the stations 2 for the identification of emission sources, and the distances (base line) between stations 2 for the identification of emission sources were within a range of 20 km to 30 km. All stations 2 for the identification of emission sources are connected to the main station 1 for the identification of emission sources via a secured local data exchange network (data transmission by wire, fiber-optic or radio channels, including GSM, 3G or 4G mobile radio communications networks).

Each of the stations 1 and 2 for the identification of emission sources comprises the antenna-feeder system (AFS) 3, the radio receiver path 4, the system for control, analysis and signals processing 5, power supply system 6.

FIG. 2 depicts the main components of the AFS 3 of stations 1 and 2 for the identification of emission sources.

An antenna mirror 7 is structurally arranged in such a way that it reflects received electromagnetic signals of 1 to 4 frequency band in the direction of an antenna feeds unit (8) which accommodates two receiving antennas for each of the specified frequency bands forming a two-beam direction pattern (DP) in a horizontal plane of 1 to 4 frequency bands.

For the formation of a dual-beam direction pattern (DP) in a horizontal plane in 0 frequency band there is an antenna 9 of right lobe of the direction pattern of 0-band and an antenna 10 of left lobe of the direction pattern of 0 frequency band.

The antenna-feeder system (AFS) contains circular direction pattern antennas operating in a horizontal plane:
an antenna 11 for the reception of GNSS signals;
an antenna 12 for the reception of IFF/TACAN signals;
an antenna 13 for the reception of signals of 5/6 frequency bands;
an antenna 14 for the reception of signals of 4 frequency band.

The antenna-feeder system (AFS) also comprises compensatory antennas with a weakly-directed direction pattern for 0-4 frequency bands:
an antenna 15 for the reception of signals of 4 frequency band;
an antenna 16 for the reception of signals of 3 frequency band;
an antenna 17 for the reception of signals of 2 frequency band;
an antenna 18 for the reception of signals of 1 frequency band;
an antenna 19 for the reception of signals of 0 frequency band.

An output of the antenna 11 for receiving GNSS signals is connected to first input of the control, 5 analysis and signals processing system. Outputs of all other antennas of the AFS 3 are connected to inputs of the calibration equipment 20 which comprises a control unit 21 of the calibration equipment, a multichannel generator 22 of reference signals, a multichannel digital attenuator 23, single-channel high-frequency switches 24 and three-channel high-frequency switches 25 consisting of three single-channel frequency switches 24. First inputs of which are the first, second and third inputs of a three-channel high-frequency switch 25 respectively, second inputs of the three single-channel high-frequency switches 24 are interconnected and are fourth input of the three-channel high-frequency switch 25.

Control inputs of three single-channel high-frequency switches 24 are interconnected and is the control input of three-channel high-frequency switch 25, and outputs of three single-channel high-frequency switches 24 are outputs of the three-channel high frequency amplifier 25. Control inputs of the multichannel generator 22 of reference signals are connected to the corresponding outputs of the control unit of calibration equipment 21 and high-frequency outputs of the multichannel generator 22 of reference signals are connected to inputs of the multichannel attenuator 23 with digital control of the corresponding frequency bands the control input of which is connected to the additional outputs of the control module 21 of calibration equipment.

Outputs of antennas with circular direction patterns in the horizontal plane (12, 13, 14) are connected to first inputs of single-channel high-frequency switches 24 of the corresponding frequency band. Second inputs of single-channel high-frequency switches 24 are connected to outputs of a multichannel attenuator 23 with digital control of the corresponding frequency band and control inputs of single-channel high-frequency switches 24 are connected to the corresponding outputs of the control unit 21 of calibration equipment.

Outputs of the antennas' feeds unit 8 forming two-beam direction pattern in a horizontal plane in 1-4 frequency bands and outputs of an antenna 9 of right lobe of direction pattern of 0-band and an antenna 10 of left lobe of direction pattern of 0-band are both connected with first and other inputs of the three-channel high-frequency switches 25 of the corresponding frequency band. Outputs of compensatory antennas 15 to 19 are connected to third inputs of three-channel high-frequency switches 25 of the corresponding frequency band fourth inputs of which are connected to outputs of a digitally-controlled multichannel attenuator 23 of the corresponding frequency band. Control inputs of three-channel high-frequency switches 25 are connected to the corresponding outputs of the calibration equipment control unit 21.

Output of an antenna 11 for receiving GNSS signals and all outputs of single-channel high-frequency switches 24 and three-channel high-frequency switches 25 are outputs of the AFS 3. They are connected to inputs of the radio receiving path 4 of the corresponding frequency band.

FIG. 3 depicts all main components of the radio receiving path 4 of stations 1 and 2 for the identification of emission sources.

An output of the AFS 3 in 5/6 frequency bands is connected to an input of an n-channel signals multiplier 26, and output of the AFS 3 in 4 frequency band is connected to an input of an m-channel signals multiplier 27.

An output of the AFS 3 in the band of IFF/TACAN signals is connected to an input of a channel “HF-IF” 28 of this frequency band and second input of the control, analysis and signals processing system 5. Output of a channel “HF-IF” 28 of the frequency band is connected to third input of the control, analysis and signals processing system 5.

Outputs of an n-channel signals multiplier 26 are connected to inputs of an n channels 28 of an “HF-IF” of 5/6 frequency bands. Outputs of an m-channel signals multiplier 27 are connected to inputs of m channels 28 “HF-IF” of 4 frequency bands and outputs of all channels 28 “HF-IF” processing signals received by antennas 13 and 14 with circular direction pattern in 4 and 5/6 frequency bands are connected to corresponding inputs of the control, analysis and signals processing system 5.

Outputs of three-channel high-frequency switches 25 of the AFS 3 in 0-4 frequency bands are connected to inputs of three-channels units of HF signals processing. Each consists of three identical 28 “HF-IF” channels of the corresponding frequency band outputs of which are IF outputs of a three-channel HF signals processing units 29 and interconnected, in addition, with inputs of three signals processing channels 30. Outputs of these channels are digital outputs of three-channels HF signal processing units and connected to inputs of a time strobes switching unit 31 and the corresponding inputs of the automated workplace 33.

IF outputs of three-channel HF signals processing units 29 of each 0 to 4 frequency bands are connected to the corresponding inputs of an IF signals switching unit 32. Outputs of the switch are connected to the corresponding inputs of the control, analysis and signals processing system 5.

Control inputs of a time strobes switching unit 31 and an IF signals switching unit 32 are connected to third output of the automated workplace 33. First output of the automated workplace is connected to data input of the control unit 20 of the calibration equipment 20 and second output is connected to the control inputs of all “HF-IF” frequency channels 28 of the radio receiver path 4.

FIG. 4 depicts the main components of an “HF-IF” channel 28 of the radio receiving path 4 which comprises a cascade of interconnected HF filters 34 an input of which is an input of the “HF-IF” channel 28 as well as an HF amplifier 35, an HF attenuator with digital control, an “HF-IF” amplifier-converter 37, an IF filter-39, an IF attenuator 40 with digital control an output of which is an output of a channel “HF-IF” 28.

FIG. 5 depicts the main elements of a video signals processing channel 30 of the radio receiver path 4 comprising a series-connected amplitude detector 41 an input of which is the input of a video signals processing channel 30, a video signals amplifier 42, a threshold device 43, and time strobes former 44 an output of which is an output of the video signals processing channel 30.

FIG. 6 shows main elements of the control, analysis and signals processing system 5 of stations 1 and 2 for the identification of emission sources.

The control, analysis and signals processing system 5 comprises a GNSS receiver 45, a receiver and a decoder 46 of IFF signals inputs of which are first inputs and second inputs of the control, analysis and signals processing system 5.

Third input of the control, analysis and signals processing system 5 for the identification of TACAN system signals is connected to an input of a single-channel meter 47 of frequency and time parameters of signals.

Similarly, (n+m) inputs of the control, analysis and signals processing system 5 are connected to inputs (n+m) of single-channel meters 47 of frequency and time signals parameters for the parallel processing of signals 4 and 5/6 of the frequency bands received by antennas 13 and 14 with circular direction pattern in a horizontal plane of the AFS 3.

A digital input of the control, analysis and signals processing system 5 is connected to a digital output of the time strobes switching unit 31.

Inputs of a three-channel meter 48 measuring frequency and time parameters of signals are inputs of the control, analysis and signals processing system 5 for the reception of IF signals of 0 to 4 frequency bands and are connected to the corresponding outputs of an IF signals switching unit 32 of the radio path 4.

Outputs of a GNSS signals receiver and an IFF signals decoder 46 and outputs of all (n+m+1) single-channel meters 47 of frequency and time signals parameters and a three-channel meter 48 of frequency and time signal parameters are connected by two-way communication lines with the station's computing system (SCS) 49.

The station's computing system (SCS) 49 is connected via bidirectional communication lines with signals selection system 50, direction finding (DF) equipment 51, the system for the identification of emission sources 52, the levelling system 53, and the support-turner control system 54.

In addition, the SCS 49 is connected via a LAN with the automated workplace (AW) 33 and via a secure local area network of data exchange of the SCS 49 of stations 1 and 2 for the identification of emission sources are also connected to the emission sources' coordinates measurement equipment 55 located in the main station for the identification of emission sources.

FIG. 7 and FIG. 8 schematically depict the placement of component parts of the levelling system 53 in stations 1 and 2 for the identification of emission sources and a block diagram of the levelling system 53, respectively.

The following components are mounted on a support-turner platform 56: an antenna mirror 7 for 1 to 4 frequency bands, a feed unit 8, an antenna 9 of right lobe of 0 frequency band, an antenna 10 of left lobe of 0 frequency band, a compensatory antenna 19 of 0 frequency band and others elements of the AFS 3. A support-turner platform 56 rotates around a vertical axis with the help of a motor-reducer 57. An antenna 11 for the reception of GNSS signals, an antenna 12 for the reception of IFF signals, and Tactical Air Navigation System (TACAN), an antenna 13 for 5/6 frequency band signals, an antenna 14 for signals of frequency band 4 (all with circular direction patterns (DP) in a horizontal plane) are located outside the support-turner (ST) platform 56.

On chassis 58, where all components of stations 1 and 2 for the identification of emission sources are located there are four beams 59 of the levelling system marked with letters L/F (left front), R/F (right front), L/R (left rear), R/R (right rear) with respect to which four movable supports 60 can be moved vertically.

For more automation of the levelling system 53 it is supplemented with horizontal sensors 61 located on the support-turner (ST) platform 56 and/or on chassis 58 as well as with four motor-reducers of the levelling system 62 and the levelling system control module 63.

Outputs of horizontal sensors 61 are connected to inputs of the control module 63 and four power outputs of the control module 63 are connected to inputs of the corresponding motor-reducers 62. The control unit 63 is run by the SCS 49 via a two-way communication line.

In general, the system for the identification of emission sources functions in the following way (in accordance with block diagrams shown in FIG. 1 to 8, and the assignments of each of the components of stations 1 and 2 for the identification of emission sources—see Table 1).

After putting stations 1 and 2 for the identification of emission sources from a transportation position to an operating position including mounting of a mirror 7 on the support-turner (ST) platform 56 of the AFS 3, the elevation of antennas 11-14 with circular direction patterns (DP) in azimuth plane to an operational height, securing a horizontal position of a support-turner (ST) platform 56 (all operations of changing positions of stations 1 and 2 for the identification of emission sources are not considered in detail as not related to the essence of the invention) high frequency signals of emission sources of 1 to 4 frequency bands are received by the mirror 7 which reflects them in the direction of a feeds unit 8 for the reception by antennas therein that form two-beam direction pattern (DP) in a horizontal plane in 1-4 frequency bands (in FIG. 2, FIG. 3 and FIG. 5 are marked I, II, III, IV respectively). Signals of emission sources of 0 frequency band are received by an antenna 9 of right lobe of the direction pattern of 0 frequency band and by an antenna 10 of left lobe of the direction pattern of 0 frequency band that both form two-beams direction pattern (DP) in the horizontal plane in 0 frequency band (in FIG. 2, FIG. 3 and FIG. 5 is marked 0). Amplitude level of these signals depends on the azimuth direction of rotation of the support-turner (ST) platform 56 (i.e., it is modulated by the amplitude of direction patterns (DP) of the corresponding pairs of antennas with available side lobes).

In addition to all antennas mentioned, compensatory antennas 15 to 19 with weakly-directed direction pattern for the reception of signals of 4 to 0 frequency signals are also mounted on the support-turner (ST) 56 platform. The main function of these compensatory antennas is to enable the availability of signals at outputs that are slightly (by 1-2 dB) exceeding a level of signals taken from azimuth directions of side lobes of antennas that form two-beam direction patterns (DP) in a horizontal plane in the corresponding frequency bands.

The simplest technical solution is the use of antennas with a circular DP as well as the use of antennas with direction pattern of a “cardioid” type a minimum azimuth coordinate of the direction pattern of which corresponds to the arithmetic mean of azimuth coordinates of the maxima of main lobes of the two-beams direction patter in a horizontal plane or, alternatively, an azimuth coordinate of the maximum of direction pattern differs by 180° from the arithmetic mean of azimut coordinates of the maxima of main lobes of the two-beam direction pattern in a horizontal plane.

By analyzing the amplitudes ratio of these signals the station's computing system (SCS) 49 can block those signals received by side lobes of two-beams direction pattern (DP) and to determine the bearing direction to emission sources the signals from which are received by the main lobes of two-beam direction pattern (DP).

In addition to that, high-frequency signals of GNSS (FIG. 2 and FIG. 5 are indicated as GPS) are received by antenna 11 of the AFS 3, high-frequency signals of the IFF system (in FIG. 2, FIG. 3 and FIG. 5 are indicated as IFF) and the tactical air navigation system TACAN (identified as TAC in FIG. 5) are received by antenna 12 of the AFS 3, high frequency signals of emission sources of 5/6 frequency bands (in FIGS. 2, 3 and 5 are marked V/VI) are received by antenna 13 of the AFS 3, high-frequency signals of emission sources of 4 frequency band (in FIG. 2, FIG. 3 and FIG. 5 are marked by V/VI) are received by antenna 14 of the AFS 3 with antennas 11-14 being located outside the support-turner platform 56 and having a circular direction pattern and the signals levels at outputs of antennas 11-14 do not depend from an azimuth direction of rotation of the support-turner platform 56.

Thus, the addition into the AFS 3 of compensatory antennas 18 to 15 in 1 to 4 frequency bands enabled the antennas to receive at their outputs in these frequency bands of initial threshold HF signals for the purpose of selection and for further determination of time and frequency parameters with the help of the system of signals selection only those signals that come from the azimuthal directions close to the main lobes of dual-beams direction pattern (DP) in a horizontal plane in the corresponding frequencies bands (signals received by side lobes are always weaker than signals of compensatory antennas). The innovation has significantly decreased false alarms rate when compared to analogous equipment.

The location of antennas 11-14 of the AFS outside a support-turner platform 56 and the provision of circular direction patterns (DP) in a horizontal plane enabled these antennas to continuously receive signals in a 360 azimuth sector in 4 and 5/6 frequency bands (no time intervals associated with possible rotations of the support-turner (ST) platform 56 for other tasks specified by an operator of the automated workplace (AW) 33 and reliable determination and accurate measurement of their frequency and time parameters with subsequent identification of emission sources ensuring a much larger number of detected sources of emission.

Another significant difference between the AFS 3 and analogous equipment is the addition into the calibration equipment 20 of a digitally-controlled multichannel attenuator 23 (between a multichannel oscillator 22 of reference signals and other inputs of single-channel HF switches 24 including those that are in the three-channel high-frequency switches 25 and connected to fourth inputs of the latter). The control input of the attenuator is connected to additional outputs of the control unit 21 of the calibration equipment which enabled automatic testing of all processing channels (from the initial cascades of the radio path 4 to outputs of single-channel meters 47 of frequency and time parameters of signals and a three-channel meter 48 of frequency and time signal parameters) not only for levels of reference signals, for example, on the upper limit of dynamic range, but also in several specific points within the dynamic range even at the sensitivity level which greatly facilitates the operation of stations 1 and 2 for the identification of emission sources and lowers requirements for an operator's qualification.

Another peculiar feature of stations 1 and 2 for the identification of emission sources of the proposed system for the identification of emission sources compared to analogous equipment is a modification of antenna mirror 7 of the AFS 3. Traditionally, when designing the AFS one seeks a reasonable tradeoff between capacity of a gear motor 57 of the support-turner (parameter—power), a decrease of a sail area of the AFS (reduction of a mirror's area, the use of perforated reflective surfaces of the mirror), increase gain ratio of the AFS (enlarged surface area of the mirror, the use of solid reflective surface of the mirror, special handling of mirror surface, such as polishing followed by applying a protective radio transparent layer).

Taking into account the placement of antennas of frequency bands 4 and 5/6 outwards of the support-turner 56 (that led to a weight decrease of the AFS 3 located on the support-turner platform 56) and an increase in the capacity of modern motor-reducers 62 while their volumetric parameters remain constant (that increases a sail area) it was found by calculations and through field tests that the size of a reflecting surface of the main mirror reduced several times when compared to analogs with the use of a metal sheet ensures gain ratio of the antennas forming two-beam direction pattern (DP) in a horizontal plane in 1-4 frequency bands sufficient to perform the identification of ground emission sources at distances of up to 700 km (with an area of 4.25 m2, the gain ratio of these antennas exceeds the analogous equipment) and the necessary operating modes of the control system 54 of the support-turner are made available with the help of motor-reducers 62.

At output of the AFS 3 there are HF signals of all antennas (in operating mode) or signals from the corresponding outputs of a digitally-controlled multichannel attenuator 23 (in test mode) that are received for processing to the radio path 4. This does not apply to signals of antenna 11 since a test mode in the reception channel of GNSS signals is carried out in the receiver of GNSS signals which is part of the control, analysis and signals processing system 5.

Signals multiplication of 5/6 and 4 frequency bands for parallel processing in multiple frequency channels at the same time is carried out in the radio receiver path 4, an n-channel multiplier 26 and an m-channel multiplier 27. The number of such channels m and n can be determined by the following formulas:

m=ΔF₄/Δf₄;n=ΔF_{5/6}/Δf_{5/6},

where m is the desired number of frequency channels in 4 frequency bands, n is the desired number of frequency channels in 5/6 frequency bands, ΔF4 is a value of frequency band 4, in our case ΔF4=4 GHz, ΔF5/6 is the value of 5/6 frequency bands, in our case ΔF5/6=6 GHz, Δf4—bandwidth of one frequency channel in 4 frequency band, Δf5/6—bandwidth of one frequency channel in 5/6 frequency bands.

For example, if one chooses the bandwidth of one frequency channel the same as in analogous equipment—0.5 GHz, then the total number of frequency channels of parallel processing will be 20 (m+n=4.0/0.5+6.0/0.5=8+12=20).

The main functions assigned to the radio receiver path 4 are provided by (m+n+1) “HF-IF” channels 28. The following functions are available for high-frequency signals of TACAN system, output signals of an n-channel multiplier 26 and an m-channel multiplier 27 in 4 and 5/6 frequency bands: the filtration (HF filter 34), amplification (HF amplifier 35), controlled attenuation (attenuator 36 HF with digital control), conversion to the intermediate frequency (amplifier-converter 37 HF-IF), filtering at intermediate frequency (IF filter 38), amplification at intermediate frequency (amplifier 39 of the IF), controlled attenuation at intermediate frequency (a digitally-controlled attenuator 40 of IF signals).

Output signals of each HF-IF channel 28 calibrated using test signals of the calibration equipment 20 can be used to determine the frequency and time parameters of the signals by the control, analysis and signals processing system 5.

The processing of HF signals from outputs of the antennas located on the support-turner platform 56 in each of 0-4 frequency bands is provided by three channel channels of HF signals processing (three channels—for a signal of the HF antenna forming right lobe of direction pattern (DP), for a signal of the HF antenna forming left lobe of direction pattern (DP) for an HF signal of the compensatory antenna), each of which contains three channels 30 for the procession of video signals (VS) successively implementing amplitude detection (an amplitude detector 41) the amplification of video signals (VS) (an amplifier 42 VS), the selection of video signals of a certain amplitude (a threshold device 43) and the formation of time strobes (a former 44 of time gates) and the three “HF-IF” channels 28 the inputs of which are the IF inputs of the three-channel unit of processing of the HF signals, and outputs of the IF outputs of the three-channel unit of processing of the HF signals, each of which, in addition, is connected with the input of its own processing channel 30, the outputs of video signals processing channels 30 are video outputs of the three-channel HF signals processing unit 29 connected to the corresponding video signal inputs of a time strobes switching unit 31 and the automated workplace (AW) 33.

The difference in output of HF signals processing algorithm of antenna 12 of the air traffic control system, an antenna 13 for the 5/6 frequency bands and an antenna 14 for 4 frequency bands compared to the HF signal processing algorithm from outputs of an antenna located on the support-turner (ST) platform 56—lies in the fact that for the latter the detection of signals of emission sources is carried out in parallel, and the determination of frequency and time parameters of these signals is carried out consistently in time intervals/schedule selected by an operator of the automated workplace (AW) 33 (automatically at detection time, automatically taking into account the priority of frequency bands and manually, etc.).

A procedure for the detection of signals from emission sources involves the following operations and steps performed in a sequence: the analysis of time strobes signals from outputs of video signals processing channels 30 at the automated workplace (AR) 33, the determination of frequency bands where signals of emission sources may be available, sending commands from the automated workplace (AW) 33 to a time strobes switching unit 31, and an IF signals switching unit 32 for the selection of signals of the assigned frequency band, processing of these command by time strobes switching units 31, and an IF signals switching unit 32 and sending video signals and IF signals to outputs of these units for the determination of frequency and time parameters of signals by the equipment of the control, analysis and signals processing system 5.

In this case, an operator is able to select a corresponding mode of operation of the support-turner (ST) system 54 of stations 1 and 2 for the identification of emission sources (a sector surveillance mode in a specified range of azimuth angles, manual mode of selection of the required bearing, etc.) for more accurate determination of signals parameters of an emission source in the selected frequency band.

In order to determine an exact location of each of stations 1 and 2 for the identification of emission sources, the values that are used in the equipment 55 for the determination of coordinates of emission sources of the main station 1 for the identification of emission sources there is a GNSS signals receiver 45 of the control, analysis and signals processing system 5. Input of the receiver is first input of the control, analysis and signal processing system 5 and an output is connected via a two-way communication link with the station's computing system (SCS) 49. Commands are issued to the GNSS receiver 45 to choose one or another global positioning system, to change operation modes of the GNSS receiver 45 including s self-test mode (BITE). The transfer of data packages in the backward direction is carried out in accordance with protocols of the specified operation mode.

Second input of the control, analysis and signals processing system 5 for processing HF signals of IFF system is connected to an input of the receiver and a decoder 46 of the IFF signals. An output of the decoder is connected via a two-way communication line with the SCS 49. Commands are issued to both a receiver and a decoder 46 of the IFF system signals to change the modes of its operation, including a test mode and to select decoding/decryption protocols. The transfer of data packages in the backward direction is carried out in accordance with protocols of the specified operation mode.

IF signals from outputs (m+n+1) of “HF-IF” channels 28 of the radio receiving path 4 at inputs of which there are TACAN signals as well as output signals of an n-channel multiplier 26 and output signals of an m-channel multiplier 27 in 4 and 5/6 frequency bands are sent to [3−(m+n+3)] inputs of the control, analysis and signal processing system 5. These inputs are at the same time inputs (m+n+1) of single-channel meters 47 of frequency and time signals parameters the outputs of which are connected via a two-way communication lines to the SCS 49.

Control commands are transmitted to one-channel meters 47 of frequency and time signals parameters to change the modes of operation (full set of parameters, the determination of frequency only, the determination of the pulse width (PW) only, the determination of only the pulse repetition period, etc.), including a test mode. The transfer of data packages in the backward direction is carried out in accordance with protocols of the specified operation mode.

IF signals from outputs of an IF signals switching unit 32 are transmitted to the corresponding inputs of a three-channel meter 48 of frequency and time parameters of signals. In terms of functionality it is identical to the operation of three single-channel meters 47 of frequency and time parameters of signals differing only in some details, for example, the availability of common interface of a two-way communication line with the SCS 49.

While data from the devices mentioned are transmitted via two-way communication lines in the station's computing system (SCS) 49 there occurs an automatic scanning of false signals using signals of a compensatory antenna as well as the rejection of signals that could be caused by impulse interference or interference of some other sort (via the signals selection system 50) the determination of azimuth direction of arrival of a signal with the specified frequency and time parameters.

Due to the use of digital methods for the determination of parameters of a signal sources the accuracy is significantly improved (with the help of the DF system 51), the definition of classes and types of emission sources, that is—identification (by means of a device for the determination of emission classes 52) and the display of results of the identification in the form of a table information or trajectory notes marked in different colors with additional symbols (depending on the frequency band and types of emission sources).

Thus, automatic identification of emission sources is the main mode of operation of the proposed system for the identification of emission sources which does not rule out a possibility, if necessary, to convert it by an operator of an automated workplace 33 into a manual mode.

When changing positions of stations 1 and 2 for the identification of emission sources from a transport position to an operational position one of the regularly done operations is levelling of the stations (ensuring a firm position of the support-turner (ST) platform 56 strictly parallel to a horizontal plane). If done manually the operation requires a 2 to 3 persons servicing team, takes about 10 minutes ensuring the required levelling accuracy within a range of 0.5° to 1.0°, depending on how qualified the personnel is.

Given that distance to an emission source may reach hundreds of kilometers, an error in calculating the distance to such a source of emission may reach several kilometers. In addition, in the course of long-lasting operation of stations 1 and 2 for the identification of emission sources (especially in field conditions) due to some mechanical vibrations and heterogeneity of soil layer, inaccuracies of levelling can reach higher values which results in an increase of an error in determining the distance to a sources of emission.

Further automation of the levelling system 53 due to addition of horizontal sensors 61 located on the support-turner platform 56 and/or chassis 58, four motor-reducers 62 and a control module 63 significantly reduces time needed to carry out an initial levelling operation to several seconds and provide a much higher levelling accuracy (up to 0.1° that is only limited by an accuracy level of the horizontal sensors 61 and the fabrication quality of surfaces upon which the horizontal sensors 61 are mounted) and also enables to monitor continuously or periodically the positioning of the support-turner (ST) platform 56 and, if necessary, adjust it using the control module 63 and available gear-motors 62.

The levelling system 53 operates in the following way. When changing positions of stations 1 and 2 for the identification of emission sources from a transportation to an operational position and just prior to start of the levelling procedure, movable supports 60 are released from a braking (stopping) position at commands from a control unit 63 (not shown in FIG. 7 and FIG. 8).

Signals of horizon sensors 61 processed by the control module 63 are transmitted via a two-way communication line to the SCS 49 where, with the help of specialized software, time intervals of operation of the corresponding motor gears 62 are calculated and sent in the form of commands at the control module 63 in which, based on data attachments to the corresponding commands, control signals are generated at four power outputs of the control module 63 and motor-reducers 62 move supports 60 within values defined by software in the SCS 49.

After that, new readings of signals of horizontal sensors 61 processed by the control module 63 are transmitted via a two-way communication line to the SCS 49 and this cycle is repeated several times ensuring that deviation from a horizontal position is within a predefined interval, for example, from minus 0.050 to 0.05°. At this step initial levelling is completed and the levelling system 53 is switched by the SCS to a mode to maintain a horizontal position of the support-turner (ST) platform 56 where data exchange between the control module 63 and the SCS 49 occurs periodically.

An interval between data packet exchange can be selected by an operator of the automated workplace (AW) 33 from a number of options depending on the chosen mode of operation of the support-turner, a type and quality of soil/ground or surface, etc. When the data supplied by horizon sensors 61 is found within a predetermined interval the levelling system 53 remains in a state of periodic data exchange with the SCS 49 without changing position of the movable supports 60. In the event that data from the horizon sensors 61 go beyond the given interval but do not exceed the limits of a hysteresis margin with limits, for example, from minus 0.150 to 0.150 the levelling system 53 continues to be in a state of periodic data exchange with the SCS 49 without changing position of the movable supports 60 but an operator's monitor at the automated workplace (AW) 33 displays an alert warning concerning possible correction of the position of the support-turner platform 56 for an operator to decide what to do (to block correction, complete a current identification procedure of an emission source, make an immediate correction, allow automatic correction, etc.). Automatic correction occurs when data from the horizontal sensors 61 exceeds the hysteresis margin.

Thus, when employing the automatic levelling system 53 a time interval needed to implement an initial levelling operation is considerably reduced (by an order of magnitude). So, the requirements for the qualification of maintenance personnel are also lowered which improves operational capabilities of the system for the identification of emission sources. In addition to that, an error margin of the determination of coordinates decreases by several orders of magnitude during the operation of the system for the identification of emission sources.

A table 2 given below shows some comparative characteristics of analogous equipment and the proposed system for the identification of emission sources. It shows a significant improvement in accuracy of determining signals parameters, coordinates, and maximum detection range of emission sources by the proposed system for the identification of emission sources. In addition, most of operations of an algorithm for the identification of emission sources are fully automated and performed without an operator's involvement which reduces requirements for an operator's qualification.

TABLE 2
Table 2.

| | | Values | |
|---|---|---|---|
| No | | Analogous | Proposed |
| μ/μ | Parameters | system | system |
| 1 | Frequency band, GHz | 0.13-18.00 | 0.13-18.00 |
| 2 | Detection range of ground targets, km | 600 | 700 |
| 3 | Panoramic surveillance band, GHz | 0.13-18.00 | 0.13-18.00 |
| 4 | RMS of coordinates measurement, MHz | 0.4 | 0.01 |
| 5 | Sensitivity, -dB/W | 140-145 | 142-148 |
| 6 | Bearing accuracy, degree | | |
| | frequency band 0.13-0.47 GHz | 3.0 | 1.0 |
| | frequency band 0.75-18.00 GHz | 0.3-0.7 | 0.1-0.3 |
| | RMS* of measurement of time parameters, μ | | |
| 7 | pulse repetition period | 0.1 | 0.01 |
| | pulse width | 0.1 | 0.01 |
| 8 | Range of measurement of pulse repetition | No data available | 5-150 000 |
| | period, μ | | |
| 9 | Number of emission sources for the | Unrestricted | Unrestricted |
| | identification | | |
| 10 | Number of vehicles | 2 | 1 |

*RMS—root mean square

Methods and techniques of calculating design parameters of antennas of the AFS for 0 to 6 frequency bands with the required direction patterns have long been known and are widely used in practice (see the following materials: Sazonov D. M., Antennas and microwave devices: A textbook for specialized radio-technical universities.—M.: Higher school, 1988; Tsybayev B. G., Romanov B. S., Antenna amplifiers.—M.: Soviet Radio, 1980), especially recently in connection with the development of wireless data transmission technologies. For example, a Schwarzbeck company, Germany (www.schwarzbeck.de) produces over 100 models of antennas in the frequency band up to 40 GHz: log-periodic, horn, pin, dipole, bicone, loop, log-spiral, etc., and also accepts orders for the manufacture of customized antennas.

The following electronic components manufactured by well-known foreign companies may be used: relays by Omron, Japan, (http://www.omron.com) as HF switches for 0-6 frequency bands of the calibration equipment 20; IC (integrated circuits) of Analog Devices, USA (www.analog.com), Texas Instruments, USA (https://www.ti.com), Motorola, USA (www.motorola.com) may be used as components of 0-1 frequency bands of the calibration equipment 20 and channels “HF-IF” of the radio receiving path 4; products of Sirenza Microdevices, China, (http://www.sirenza.com), Atlantes, Israel (http://www.atlantese.com) as well as micro assemblies by MCS (Microwave Components and Systems), Russian Federation, St. Petersburg, (http://mwaves.ru) may be used as components of 2-4 frequency bands of the calibration equipment 20 and channels “HF-IF” of the radio receiving path 4.

Single-channel meters of frequency and time signal parameters and a three-channel meter of frequency and time parameters of the control, analysis and signals processing system can be implemented on the basis of high-performance ADC by Analog Devices, Texas Instruments and analogue programmable logic integrated circuits (FPGAs) by Altera, USA, (www.altera.com), Xilinx, USA (http://www.xilinx.com).

Three-coordinate accelerometers (accelerometer sensors) can be used to implement the levelling system, for example, the LIS331DLH integrated circuit (STMicroelectronics, Italy/France (www.st.com) which utilizes digital serial interface for output of 12 bit data; as gear motors—worm motor-reduces of ECM type by Transtecno, Italy, (http://www.transtecno.com) may be used as gear motors, as a processor for the control module the controllers by Atmel, USA, (http://www.transtecno.com), Microch ip, USA, (http://www.microchip.com) may be used.

Thus, each component of stations 1 and 2 for the identification of emission sources of the proposed system for the identification of emission sources can be implemented on the basis of known technical solutions and technological processes using COTS components.

Consequently, the proposed invention enables to increase the probability of correct and accurate determination of coordinates of radio emission sources as well as to expand modes of operation of the system with the automatic identification of emission sources and to ensure stability of parameters of the system during its operation and to increase the detection range up to 700 km.

What is claimed is:

1.-4. (canceled)

5. A system for an identification of emission sources, consisting of at least four stations for the identification of the emission sources; a first main station for the identification of the emission sources is equipped with an equipment intended for processing its own data and data received from other stations using specialized software for calculating coordinates of each of the detected radio emission sources in 0-6 frequency bands; other three stations for the identification of the emission sources are placed on a terrain at distances of 20-30 kilometers from the first main station; each station for the identification of the emission sources comprises an antenna-feeder system with a rotary support frame and a calibration equipment, a radio receiving path with an automated workplace, a control, analysis and signal processing system, a leveling system and a power supply system that supplies energy to all component parts of the station for the identification of the emission sources; the antenna-feeder system contains a 1-4th frequency bands mirror made of a solid metal sheet in a form of a paraboloid part, with a feeds unit of I-4th frequency bands and designed to collectively enable a left and a right lobes of direction patterns of the antenna-feeder system: it also contains an antenna system of a 0 frequency band, consisting of two antennas, enabling a left and a right lobes of a direction pattern and a compensatory antenna with a weakly-directed direction pattern; a support and rotary assembly provides scanning of a surrounding area within a range of 360° in azimuth; the calibration equipment consists of a control module, a multichannel reference signal generator and high-frequency switches in each of the frequency bands; first inputs of the high-frequency switches are connected to outputs of all the antennas in each of the frequency bands; all outputs of the high-frequency switches are, in fact, outputs of the antenna-feeder system, and control inputs of the high-frequency switches are connected to corresponding outputs of the calibration equipment control module, a data input of which is connected to a first output of the automated workplace; the radio receiving path comprises a multi-channel radio receiver with “HF-IF” channels in each of the 0-4 frequency bands for processing of signals of the left and the right lobes of the antenna-feeder system's direction patterns, and a “HF-IF” channel for processing signals of the compensatory antenna of the 0 frequency band, channels for formation of video signals of the left and the right lobes of the direction patterns and a video signal of the 0 frequency band compensatory antenna of the antenna-feeder system; a video signals switching unit and an intermediate frequency (IF) signals switching unit, which is connected with inputs to corresponding “HF-IF” channel outputs and inputs of the video signal formation channels of each of the 0-4 frequency bands; each “HF-IF” channel consists of series-connected a high-pass filter, a high-frequency preamplifier, a high-frequency attenuator, a “high frequency-intermediate frequency” converter-amplifier, an intermediate frequency filter, an intermediate frequency amplifier, an intermediate frequency attenuator; an input of the high-pass filter is an input of the “HF-IF” channel and is connected to a corresponding output of the antenna-feeder system; an output of the intermediate frequency attenuator is an output of the “HF-IF” channel; inputs of the high and intermediate frequency attenuators as well as inputs of the “high frequency-intermediate frequency” converter-amplifiers of each of the “HF-IF” channels are connected to a second output of the automated workplace; each video signal formation channel consists of a series-connected amplitude detector, a video signal amplifier, a threshold device, and a time gate former; an input of the amplitude detector is the input of the video signal formation channel, and an output of the time gate former is an output of the video signal formation channel; all outputs of the video signal formation channels are connected to corresponding inputs of the video signals switching unit and the automated workplace; all control inputs of the video signals switching unit and the intermediate frequency signals switching unit are connected to a third output of the automated workplace, and all outputs of the video signals switching unit and all outputs of the intermediate frequency signals switching unit are video signals outputs and outputs at the intermediate frequency of the radio path of the left and the right lobes of direction pattern in the selected frequency band connected to corresponding inputs of a station's computing system; the control, analysis and signals processing system contains the station's computing system connected by two-way communication lines to the automated workplace and a receiver of global positioning systems; an input of this receiver is connected to an output of a global positioning systems' signals receiving antenna, as well as to a receiver and a decoder of signals of the identification friend or foe (IFF) system; adecoder input is connected to an output of a receiving antenna of the identification friend or foe (IFF) system and a tactical air navigation system (TACAN), as well as to a signals selection system, a direction finding equipment, an emission sources recognition and identification equipment and a control system of the support and rotary assembly of the antenna-feeder system; an output of the signals selection system is connected to a control input of the direction finding equipment, and the computing system of the main station is connected viaa secure local area network to the equipment for determining the coordinates of the emission sources located on it and to the computing systems of the other stations for identifying the emission sources;
wherein the antenna-feeder system incorporates compensatory antennas of 1-4 frequency bands with weakly-directed direction patterns and antennas of 4, 5/6 frequency bands and a band of signals emitted by the identification friend or foe (IFF) system and the tactical air navigation system (TACAN) with circular direction patterns;
the antenna-feeder system calibration equipment has a multi-channel attenuator with a digital control in each of the frequency bands between outputs of the multichannel reference signal generator and other inputs of the high-frequency switches; all control inputs of the attenuator are connected to additional outputs of the calibration equipment control module; a radio reception channel in each of the 1-4 frequency bands additionally has “HF-IF” and video signal processing channels for processing signals of the compensatory antennas of the 1-4 frequency bands with the weakly-directed direction patterns; the outputs of the “HF-IF” channels are connected to corresponding additional inputs of the IF signals switching unit and inputs of the additionally added video signals processing channels, outputs of which are connected with corresponding additional inputs of the video signals switching unit and inputs of the automated workplace; in addition, an “HF-IF” channel has been added for processing signals of an antenna with a circular direction pattern in a frequency band of the tactical air navigation system signals, an n-channel multiplier of the signals and “HF-IF” n-channels for processing the signals of the antenna with the circular direction pattern in 5/6 frequency bands, an m-channel multiplier of the signals and “HF-IF” m-channels for processing the signals of the antenna with the circular direction pattern in the 4 frequency band; the control, analysis and signal processing system includes a single-channel frequency and time meter for signals from the tactical navigation system, an input of which is connected to an output of the “HF-IF” channel for processing the tactical air navigation system signals and n-single-channel meters for frequency and time parameters of the signals in the 5/6 frequency bands; the inputs of these meters are connected to outputs of the “HF-IF” n-channels for processing the signals of the antenna with the circular direction pattern in the 5/6 frequency bands; inputs of m-single-channel meters of frequency and time parameters of the signals in the 4 frequency band are connected to outputs of the “HF-IF” m-channels for processing the signals of the antenna with the circular direction pattern in the 4 frequency band; all inputs of a three-channel meter of the frequency and the time parameters of the signals are connected to outputs of the intermediate frequency signals switching unit, all the single-channel meters of the frequency and the time parameters of the signals and the three-channel meter of the frequency and the time parameters of the signals are connected to the station's computing system via additional two-way communication lines; the equipment of the each station for the identification of the emission sources is mounted on a chassis of an off-road truck; a levelling system of the each station for the identification of the emission sources consists of four movable supports placed on beams at sides of the chassis and is automatically controlled by four geared motors; a possibility of vertical movement of the movable supports is provided in accordance with readings of horizon sensors fixed on a platform of the rotary support or on the chassis using a control module, signal inputs of which are connected to outputs of the horizon sensors; four outputs of the control module are connected to power inputs of the respective gear motors, and the control module is connected via the two-way communication line with the station's computing system.

6. The system for the identification of the emission sources according to claim 5, wherein the compensatory antennas of the 1-4 frequency bands are made with circular direction patterns.

7. The system for the identification of the emission sources according to claim 5, wherein the compensatory antennas of the 1-4 frequency bands are made with direction patterns of a “cardioid” type, an angular coordinate of a maximum of which differs by 180° from an arithmetic average of angular coordinates of a maximum values of the left and the right lobes of the direction patterns of the antenna-feeder system in the appropriate frequency band.

8. The system for the identification of the emission sources according to claim 5, wherein the main mirror of the antenna-feeder system is made with an area of at least 4.25 m².
